(19) United States
(12) Patent Application Publication
(10) Pub. No.: US 2025/0259288 A1
(43) Pub. Date: Aug. 14, 2025

(54) TRAINING AND USING A NEURAL NETWORK FOR DEFECT DETECTION

(71) Applicant: Applied Materials Israel Ltd., Rehovot (IL)

(72) Inventors: Lior KATZ, Jerusalem (IL); Tomer MELAMED, Jerusalem (IL)

(21) Appl. No.: 18/439,748

(22) Filed: Feb. 12, 2024

(51) Int. Cl. G06T 7/00

(52) U.S. Cl. CPC G06T 7/0004; G06T 2207/20081; G06T 2207/20084

(57) ABSTRACT

A system for training a model representing elements in the input space, each having N dimensions and being associated with images of a semiconductor specimen, to a latent space representing an equal number of elements each having M (M≤N) dimensions. The system includes a processor configured to obtain a desired probability function for transformation of the elements in the input space cluster(s) s of elements in the latent space. Then, using the desired probability function to repeatedly transform, until a specified criterion is met, elements in the input space to equal elements in the latent space in compliance with an actual probability function that is indicative of an actual allocation of the elements to the cluster(s). Lastly, determining a training loss value L associated with the elements in the latent space and testing if the training loss value L meets the specified criterion.

### TECHNICAL FIELD

The presently disclosed subject matter relates, in general, to the field of training and using a neural network for defect detection.

### BACKGROUND

Current demands for high density and performance associated with ultra large-scale integration of fabricated devices require submicron features, increased transistor and circuit speeds, and improved reliability. As semiconductor processes progress, pattern dimensions, such as line width, and other types of critical dimensions, are continuously shrunken. Such demands require formation of device features with high precision and uniformity, which, in turn, necessitates careful monitoring of the fabrication process, including automated examination of the devices while they are still in the form of semiconductor wafers.

Examination can be provided by using non-destructive examination tools during or after manufacture of the specimen to be examined. Examination generally involves generating certain output (e.g., images, signals, etc.) for a specimen by directing light or electrons to the wafer, and detecting the light or electrons from the wafer. A variety of non-destructive examination tools includes, by way of non-limiting example, scanning electron microscopes, atomic force microscopes, optical inspection tools, etc.

Examination processes can include a plurality of examination steps. The manufacturing process of a semiconductor device can include various procedures such as etching, depositing, planarization, growth such as epitaxial growth, implantation, etc. The examination steps can be performed a multiplicity of times, for example after certain process procedures, and/or after the manufacturing of certain layers, or the like. Additionally, or alternatively, each examination step can be repeated multiple times, for example for different wafer locations, or for the same wafer locations with different examination settings.

Examination processes are used at various steps during semiconductor fabrication for performing e.g. defect related operations. Effectiveness of examination can be improved by automatization of certain process(es) such as, for example, defect detection, Automatic Defect Classification (ADC), Automatic Defect Review (ADR), image segmentation and/or other operations, etc. Automated examination systems ensure that the parts manufactured meet the quality standards expected and provide useful information on adjustments that may be needed to the manufacturing tools, equipment, and/or compositions, depending on the type of errors identified, so as to promote higher yield.

### SUMMARY

In accordance with an aspect of the invention, there is provided a system for training a model representing a plurality of elements in the input space, each having N dimensions and being associated with at least one image of a semiconductor specimen, to a latent space representing an equal plurality of elements, each having M (MEN) dimensions, the system comprising a processing and memory circuitry (PMC) configured to:
a) obtain a desired probability function for transformation of the elements in the input space into one or more respective clusters of elements in the latent space;
b) using the desired probability function to repeatedly transform, until a specified criterion is met, elements in the input space to equal the plurality of elements in the latent space in compliance with an actual probability function that is indicative of an actual allocation of the elements to the one or more respective clusters;
c) determining a training loss value L associated with the elements in the latent space and testing if the training loss value L meets the specified criterion; the training loss value L being determined based on at least:
   a. a first term L_{Rec} indicative of a distance between the elements in the input space and elements in an output space reconstructed from the elements in the latent space; and
   b. a second term, L_{Prob} indicative of statistical distance between the desired probability function and the actual probability function.

In addition to the above features, the system according to this aspect of the presently disclosed subject matter can comprise one or more of features (i) to (xi) listed below, in any desired combination or permutation which is technically possible:
(i) wherein said training loss value L complies with the following equation:

$$α * {L}_{Rec} + ( 1 - α ) * {L}_{Prob}$$

(ii) wherein the system facilitates more efficient analysis of elements associated with the actual probability function that is sufficiently similar to the desired probability function in the latent space, rather than hypothetical analysis of the elements in the input space which inherently do not comply with the specified desired probability function.
(iii) wherein the training is a semi or fully supervised learning such that at least some of the plurality of elements in the input space are labeled with respective class of at least two classes for transformation of the elements in the input space into elements in one or more respective clusters of elements in the latent space.
(iv) wherein elements in the input space are allocated to a number (I≥2) of mutually discernible clusters in the latent space and the (PMC) is further configured to:
   a. obtain data indicative of a number (K≥I) of classes each associated with a respective group of classes for each cluster, giving rise to/groups of classes;
   b. label each element of at least a subset of the input space with a selected class of said K classes;
   c. determine the training loss L value based also on:
a third term, L_{Sup} indicative of a degree of allocation of the transformed elements, labeled with classes each associated with a respective group of the/group of classes, to a corresponding cluster of the I clusters, such that the fewer the transformed elements that are allocated to other than the corresponding cluster of said/clusters, the lower the L_{Sup} value.
(v) wherein said training loss value L complies with the following equation:

$$α * {L}_{Rec} + β * {L}_{Prob} + ( 1 - α - β ) * {L}_{Sup}$$

(vi) wherein elements in the input space are allocated to a number (I≥2) of mutually discernible clusters in the latent space and the (PMC) is further configured to:
   d. obtain data indicative of a number (k<I) of classes;
   e. label each element of at least a subset of the input space with a selected class of said K classes;
   f. determine the training loss L value based also on:

a third term, L_{Sup} indicative of a degree of allocation of the transformed elements, labeled with k classes to a corresponding cluster of the I clusters, such that the fewer the transformed elements that are allocated to other than the corresponding cluster of the/clusters, the lower the L_{Sup} value.
(vii) wherein the model being a neural network that includes an encoder and decoder.

(viii) wherein the statistical distance between the desired probability function and the actual probability function is calculated utilizing Jenson Shannon or Kullback-Leibler divergences.

(ix) wherein at least one of the clusters is characterized by a known statistical distribution.

(x) wherein at least two of the clusters are characterized by Gaussian Mixture Modeling (GMM) or Gaussian.

(xi) wherein the N dimensions input space associated with at least one image are informative of pixel values and/or at least two of the following: average intensity level, deviation from average pixel value, defect size, SNR (signal to noise ratio), correlation with predefined template, image moments.

In accordance with other aspects of the presently disclosed subject matter, there is provided a system for utilizing a trained model for analyzing elements in a latent space; the latent space representing a plurality of elements each having M dimensions that were transformed from elements in an input space having N (M≤N) dimensions and being associated with at least one image of a semiconductor specimen; the transformed elements comply with a probability function; the system comprising a processing and memory circuitry (PMC) configured to:
a) obtain at least one element in the input space that is associated with an image of a semiconductor specimen;
b) utilizing the trained model for transforming the at least one element to an equal number of elements in the latent space;
c) for each transformed element, determine the distance between the element and reference to the probability function, wherein examination of the element is based on the determined distance.

This aspect of the disclosed subject matter can comprise one or more of features (i) to (v) listed below with respect to the system, mutatis mutandis, in any desired combination or permutation which is technically possible.
(i) wherein said reference to the probability function being the center of the probability function.
(ii) wherein the model was trained by a PMC, including:
   a) obtaining a desired probability function for transformation of the elements in the input space into one or more respective clusters of elements in the latent space;
   b) using the desired probability function to repeatedly transform, until a specified criterion is met, elements in the input space to equal the plurality of elements in the latent space in compliance with an actual probability function that is indicative of an actual allocation of the elements to the one or more respective clusters;
   c) determining a training loss value L associated with the elements in the latent space and testing if the training loss value L meets the specified criterion; the training loss value L being determined based on at least:
      a. a first term L_{Rec} indicative of a distance between the elements in the input space and elements in an output space reconstructed from the elements in the latent space; and
      b. a second term, L_{Prob} indicative of statistical distance between the desired probability function and the actual probability function.
(iii) wherein the analysis includes determining anomality of the transformed elements.
(iv) wherein the analysis includes determining association of each transformed element to a cluster of the clusters.
(v) wherein the analysis includes generating at least one new element in the latent space being re-constructible to a corresponding at least one output element in the output space wherein each of the at least one output element constitutes a new synthetic input element for training a model.

In accordance with other aspects of the presently disclosed subject matter, there is provided a method for training a model representing a plurality of elements in the input space each having N dimensions and being associated with at least one image of a semiconductor specimen, to a latent space representing an equal plurality of elements each having M (M≤N) dimensions, the method comprising, by a processing and memory circuitry (PMC):
a) obtaining a desired probability function for transformation of the elements in the input space into one or more respective clusters of elements in the latent space;
b) using the desired probability function to repeatedly transform, until a specified criterion is met, elements in the input space to equal the plurality of elements in the latent space in compliance with an actual probability function that is indicative of an actual allocation of the elements to the one or more respective clusters;
c) determining a training loss value L associated with the elements in the latent space and testing if the training loss value L meets the specified criterion; the training loss value L being determined based on at least:
   a. a first term L_{Rec} indicative of a distance between the elements in the input space and elements in an output space reconstructed from the elements in the latent space; and
   b. a second term, L_{Prob} indicative of statistical distance between the desired probability function and the actual probability function.

This aspect of the disclosed subject matter can comprise one or more of features (i) to (xi) listed above with respect to the system, mutatis mutandis, in any desired combination or permutation which is technically possible.

In accordance with other aspects of the presently disclosed subject matter, there is provided a method for utilizing a trained model for analyzing elements in a latent space; the latent space representing a plurality of elements each having M dimensions that were transformed from elements in an input space having N (M≤N) dimensions and being associated with at least one image of a semiconductor specimen; the transformed elements comply with a probability function; the method comprising, by a processing and memory circuitry (PMC):
a. obtaining at least one element in the input space that is associated with an image of a semiconductor specimen;
b. utilizing the trained model for transforming the at least one element to an equal number of elements in the latent space;
c. for each transformed element, determining the distance between the element and reference to the probability function, wherein examination of the element is based on the determined distance.

This aspect of the disclosed subject matter can comprise one or more of features (i) to (v) listed above with respect to the system, mutatis mutandis, in any desired combination or permutation which is technically possible.

In accordance with other aspects of the presently disclosed subject matter, there is provided a non-transitory computer readable storage medium tangibly embodying a program of instructions that, when executed by a computer, cause the computer to perform a method for training a model representing a plurality of elements in the input space, each having N dimensions and being associated with at least one image of a semiconductor specimen, to a latent space representing an equal plurality of elements each having M (M≤N) dimensions, the method comprising, by a processing and memory circuitry (PMC):
a) obtaining a desired probability function for transformation of the elements in the input space into one or more respective clusters of elements in the latent space;
b) using the desired probability function to repeatedly transform, until a specified criterion is met, elements in the input space to equal the plurality of elements in the latent space in compliance with an actual probability function that is indicative of an actual allocation of the elements to the one or more respective clusters;
c) determining a training loss value L associated with the elements in the latent space and testing if said training loss value L meets the specified criterion; said training loss value L being determined based on at least:
   a. a first term L_{Rec} indicative of a distance between the elements in the input space and elements in an output space reconstructed from the elements in the latent space; and
   b. a second term, L_{prob} indicative of statistical distance between the desired probability function and the actual probability function.

This aspect of the disclosed subject matter can comprise one or more of features (i) to (xi) listed above with respect to the system, mutatis mutandis, in any desired combination or permutation which is technically possible.

In accordance with other aspects of the presently disclosed subject matter, there is provided a non-transitory computer readable storage medium tangibly embodying a program of instructions that, when executed by a computer, cause the computer to perform a method for utilizing a trained model for analyzing elements in a latent space; the latent space representing a plurality of elements each having M dimensions that were transformed from elements in an input space having N (M≤N) dimensions and being associated with at least one image of a semiconductor specimen; the transformed elements comply with a probability function; the method comprising, by a processing and memory circuitry (PMC):
a. obtaining at least one element in the input space that is associated with an image of a semiconductor specimen;
b. utilizing the trained model for transforming the at least one element to an equal number of elements in the latent space;
c. for each transformed element, determine the distance between the element and reference to the probability function, wherein examination of the element is based on the determined distance.

This aspect of the disclosed subject matter can comprise one or more of features (i) to (v) listed above with respect to the system, mutatis mutandis, in any desired combination or permutation which is technically possible.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 illustrates a generalized block diagram of a training system in accordance with certain embodiments of the presently disclosed subject matter;

FIG. 2 illustrates a generalized block diagram of a sequence of operations, for training a model, in accordance with certain embodiments of the presently disclosed subject matter;

FIG. 3A illustrates, schematically, elements in a latent space that were transformed into a single cluster in compliance with a desired probability function, in accordance with certain embodiments of the presently disclosed subject matter;

FIG. 3B illustrates, schematically, elements in a latent space that were transformed into two clusters in compliance with a desired probability function, in accordance with certain embodiments of the presently disclosed subject matter;

FIG. 3C-E illustrate, schematically, three respective examples of transforming elements from input space into elements in a latent space, in accordance with certain embodiments of the presently disclosed subject matter;

FIG. 4 illustrates a generalized block diagram of an inference system, in accordance with certain embodiments of the presently disclosed subject matter; and

FIG. 5 illustrates a generalized block diagram of a sequence of operations performed in an inference system, in accordance with certain embodiments of the presently disclosed subject matter.

### DETAILED DESCRIPTION OF EMBODIMENTS

In the field of, say, analyzing input elements of semiconductor specimens (such as wafers), processing numerous input elements, each associated with data indicative of many dimensions (see below) may hinder successful analysis of such input elements (e.g., determining whether an input element is a defect, detecting anomalies, determining whether an element falls into any one designated class, and others.

Intuitively, in accordance with certain embodiments, there is provided a system for training a model for reducing an input space representing a plurality of elements, each having N dimensions (say, average intensity level, deviation from average pixel value of a matrix of pixels etc.) and being associated with image(s) of a semiconductor specimen, to a latent space representing an equal plurality of elements, each having M (M≤N) dimensions. The processing may include:
a) obtaining a desired probability function (say, Gaussian) for allocation of the elements in the input space into one or more respective clusters of elements in the latent space;
b) using the desired probability function to repeatedly transform, until a specified criterion is met, elements in the input space to equal plurality elements in the latent space in compliance with an actual probability function that is indicative of an actual allocation of the elements to the one or more respective clusters;
c) determining a training loss value L associated with the elements in the latent space and testing if said training loss value L meets the specified criterion; said training loss value L being determined based on at least:
   a. a first term L_{Rec} indicative of a distance between the elements in the input space and reconstructed elements in a reconstructed space, re-constructible from the elements in the latent space; and
   b. a second term, L_{prob} indicative of statistical distance between the desired probability function and the actual probability function.

Elements in the context of the invention should be construed to be indicative of a portion (e.g. an image portion) of a semiconductor specimen (e.g. a die or wafer) including but not limited a normal portion, a defect of interest (DOI)-referred to occasionally also as “defect”, a nuisance which may indicate an abnormal portion which is of no interest and/or is not regarded as a defect, etc. As is well known, a defect in a semiconductor die can occur at any stage of the manufacturing process, from the initial growth of the silicon wafer to the final packaging of the IC (define this?). These defects can range in size from microscopic imperfections to large cracks or chips. There are many different types of semiconductor die defects, for instance, particle contamination, structural defects, process defects, etc.

Dimensions in the context of the invention should be extensively construed to include data associated with an element. For instance, the dimensions may be informative of pixel values. Consider, by way of example, that an element being informative of a matrix of 32×32 pixels (as extracted from a die) and the N=1024 dimensions are the grey level pixel values thereof. By way of another example, the N dimensions may be indicative of the meta data associated with the element. For instance, consider the previous example of an element being informative of a matrix of 32×32 pixels (e.g. as extracted from a die), the N dimesons may be for instance at least two of the following: average intensity level, deviation from average pixel value defect size, SNR (signal to noise ratio), correlation with a predefined template, image moments and/or others, depending upon the particular application. Note that the invention is not bound by these examples.

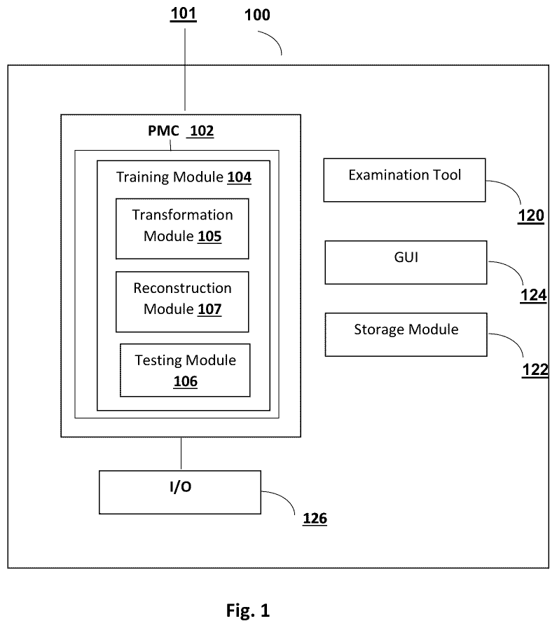

Bearing this in mind, attention is drawn to FIG. 1 illustrating a functional block diagram of an examination system in accordance with certain embodiments of the presently disclosed subject matter.

The examination system 100 illustrated in FIG. 1 can be used for examination of elements in a specimen (e.g., a semiconductor wafer, a die, or parts thereof) as part of the specimen fabrication process. The examination referred to herein can be construed to cover any kind of operations related to defect inspection/detection, defect classification, segmentation, operations, such as, e.g., critical dimension (CD) measurements, overlay, etc., with respect to the specimen. System 100 comprises one or more examination tools 120 configured to scan a specimen and capture images thereof to be further processed for various examination applications.

Without limiting the scope of the disclosure, it should also be noted that the examination tools 120 can be implemented as inspection machines of various types, such as optical inspection machines, electron beam inspection machines (e.g., Scanning Electron Microscope (SEM) [e.g., defect review,], Atomic Force Microscopy (AFM), or Transmission Electron Microscope (TEM), etc.), and so on. In some cases, the same examination tool can provide low-resolution image data and high-resolution image data. The resulting image data (low-resolution image data and/or high-resolution image data) can be transmitted, directly or via one or more intermediate systems, to system 101. The present disclosure is not limited to any specific type of examination tools and/or the resolution of image data resulting from the examination tools.

In some embodiments, at least one of the examination tools 120 can be configured to capture images and perform operations on the captured images.

According to certain embodiments, the examination tool can be an electron beam tool, such as, e.g., a scanning electron microscope (SEM). SEM is a type of electron microscope that produces images of a specimen by scanning the specimen with a focused beam of electrons. The electrons interact with atoms in the specimen, producing various signals that contain information on the surface topography and/or composition of the specimen.

According to certain embodiments of the presently disclosed subject matter, the examination system 100 comprises a computer-based system 101 operatively connected to the examination tools 120 including but not limited to on-line operation, where images obtained by the examination tool are processed by the various modules of PMC 102, or, in accordance with other non-limiting embodiments, images obtained by examination tool 120 are received through I/O module 126, and stored in storage module 122 for later off-line processing by PMC 102, all as will be explained in greater detail below.

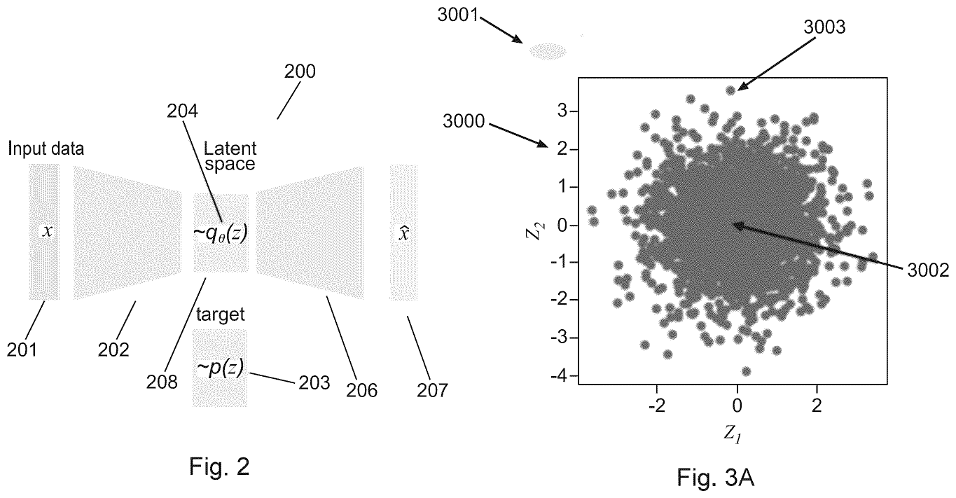

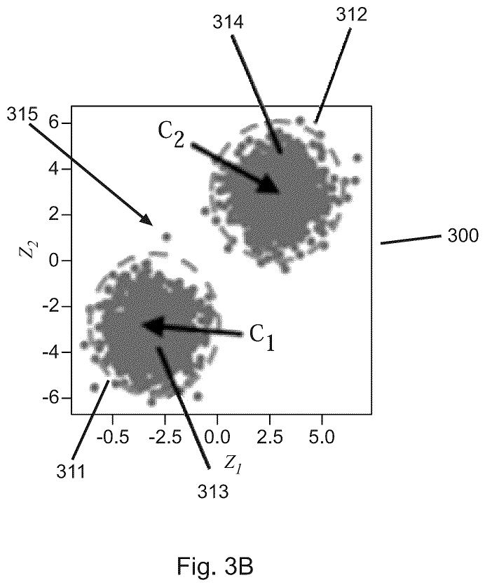

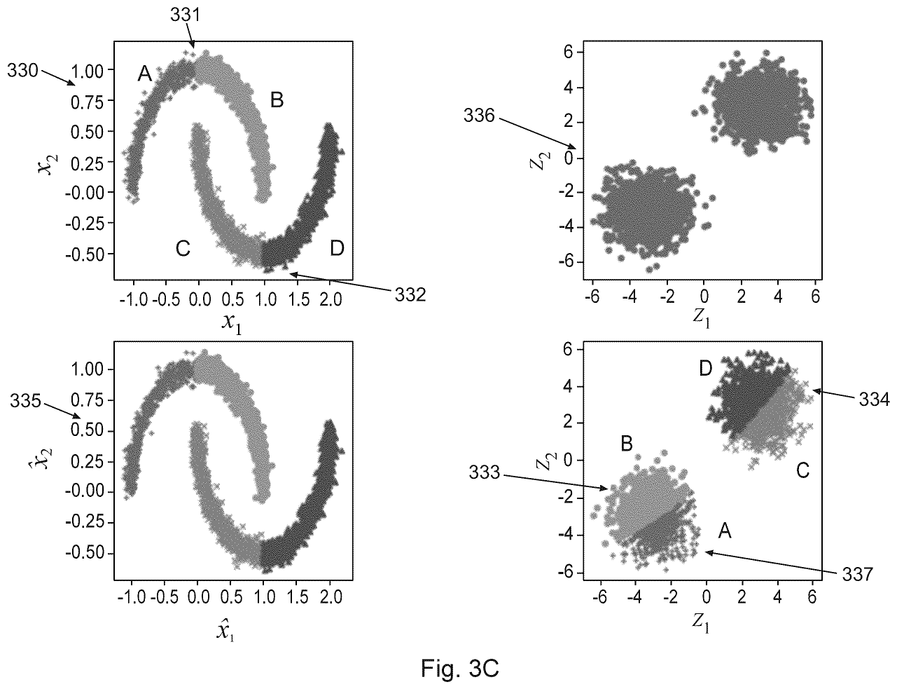

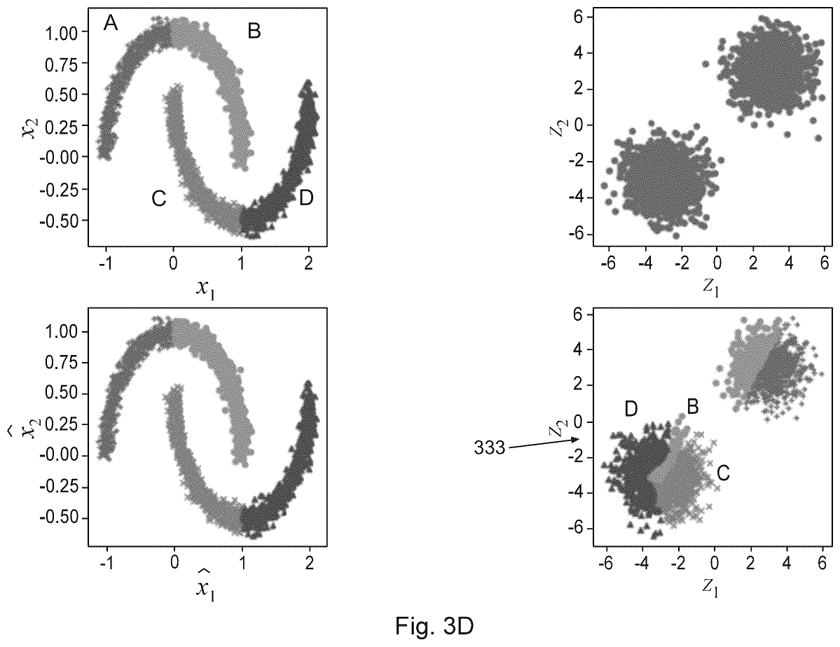

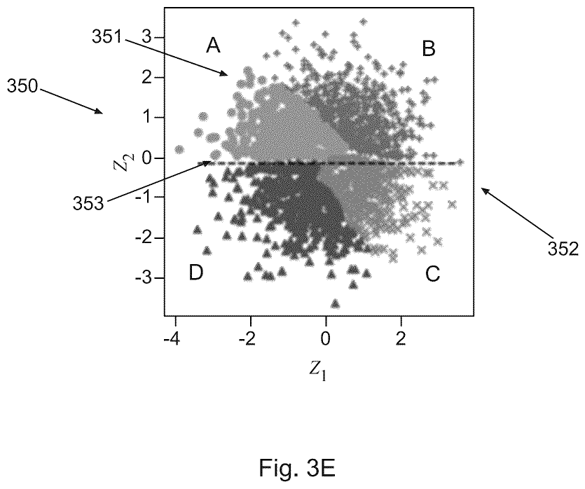

Specifically, system 101 includes a processor and memory circuitry (PMC) 102 operatively connected to a hardware-based I/O interface 126. The PMC 102 is configured to provide processing necessary for operating the system, as further detailed with reference to FIGS. 2 to 3 and comprises one or more processors (not shown separately) operatively connected to a memory (not shown separately). The processor(s) of PMC 102 can be configured to execute several functional modules in accordance with computer-readable instructions implemented on a non-transitory computer-readable memory comprised in the PMC. Such functional modules are referred to hereinafter as comprised in the PMC.

Functional modules comprised in the PMC 102 of system 101 can include, e.g., a training module 104, which, in turn, can include transformation module 105, reconstruction module 107, and criterion testing module 106.

The PMC 102 can be configured to obtain, via the I/O interface 126 and from the examination tool 120, data indicative of a desired probability function for allocation of the elements in the input space into one or more respective clusters of elements in the latent space, all as will be explained in greater detail below.

Operation of systems 100, 101, 102, and the PMC(s) thereof, as well as the functional modules therein, will be further detailed with reference to FIGS. 2-3 for training a model for reducing an input space representing a plurality of elements each having N dimensions and being associated with at least one image of a semiconductor specimen, to a latent space representing an equal plurality of elements each having M (M≤N) dimensions.

In some cases, additionally to system 101, the examination system 100 can comprise one or more examination modules, such as, e.g., defect detection module and/or Automatic Defect Review Module (ADR), and/or Automatic Defect Classification Module (ADC,) and/or other examination modules which are usable for examination of a specimen. The one or more examination modules can be implemented as stand-alone computers, or their functionalities (or at least part thereof) can be integrated with the examination tool 120. In some cases, the output of system 101 such as, e.g., the images that are associated with data indicative of the contour of the bottom of the hole, can be provided to the one or more examination modules for further processing.

According to certain embodiments, system 101 can comprise a storage unit 122. The storage module 122 can be configured to store any data necessary for operating system 101, e.g., data related to input and output of system 101, as well as intermediate processing results generated by system 101. By way of example, the storage module 122 can be configured to store images of the specimen and/or derivatives thereof produced by the examination tool 120. Accordingly, the images can be retrieved from storage module 122 and provided to the PMC 102 for further processing. The output of system 101 can be sent to storage module 122 to be stored. The specified storage unit may further store, by way of example, desired probability function, training criterion, training loss value L etc., all as will be explained in greater detail below.

In some embodiments, system 100 can optionally comprise a computer-based Graphical User Interface (GUI) 124 which is configured to enable user-specified inputs related to system 101. For instance, the user can be presented with a visual representation of the specimen (for example, by a display forming part of GUI 124), including image data of the specimen. The user may be provided, through the GUI, with options of defining certain operation parameters. The user can also annotate the reference image via the GUI. The user may also view the operation results on the GUI.

In some cases, system 101 can be further configured to send, via I/O interface 126, the output data to one or more of the examination tools 120 and/or the one or more examination modules as described above, for further processing. In some cases, system 101 can be further configured to send certain output data to the storage module 122, and/or external systems (e.g., Yield Management System (YMS) of a fabrication plant (FAB)).

Those versed in the art will readily appreciate that the teachings of the presently disclosed subject matter are not bound by the system illustrated in FIG. 1, and in particular not by any of the specified modules 104, 105, 106, and 107, and/or by the operations performed thereby, as described below with reference to FIGS. 2-3. Equivalent and/or modified functionality can be consolidated or divided in another manner and can be implemented in any appropriate combination of software with firmware and/or hardware.

It is noted that the system illustrated in FIG. 1 can be implemented in a distributed computing environment, in which the aforementioned components and functional modules shown in FIG. 1 can be distributed over several local and/or remote devices, and can be linked through a communication network. For instance, the examination tool 120 and the system 101 can be located at the same entity (in some cases hosted by the same device) or distributed over different entities.

It is further noted that in some embodiments at least some of examination tools 120, storage module 122, and/or GUI 124 can be external to the examination system 100 and operate in data communication with systems 100 and 101 via I/O interface 126. System 101 can be implemented as stand-alone computer(s) to be used in conjunction with the examination tools, and/or with the additional examination modules as described above. Alternatively, the respective functions of the system 101 can, at least partly, be integrated with one or more examination tools 120, thereby facilitating and enhancing the functionalities of the examination tools 120 in examination-related processes.

Although it is illustrated in FIG. 1, in some cases the functionalities of system 110 can be at least partly integrated with system 100. By way of example, the functional modules of system 110 can be incorporated into the PMC 102 in system 101.

While not necessarily so, the process of operation of systems 101 and 100 can correspond to some or all of the stages of the methods described with respect to FIGS. 2-3. Likewise, the methods described with respect to FIGS. 2-3 and their possible implementations, can be implemented by systems 101 and 100, possibly utilizing modules 104, 105, 106, and 107. It is therefore noted that embodiments discussed with respect to FIGS. 2-3 can also be implemented, mutatis mutandis, as various embodiments of the systems 101 and 100, and vice versa.

Attention is now drawn to FIG. 2, illustrating a generalized block diagram of a sequence of operations, for training a model 200, in accordance with certain embodiments of the presently disclosed subject matter. Note that the training of the model may be performed in training module 104 that may utilize “black box” modules (105 and 107) for the training and reconstruction operations.

As shown, the input (designated as x 201) so-called input space represents a plurality of elements, each having N dimensions and being associated with at least one image of the semiconductor specimen. In many applications, there may be numerous elements and a large number (N) of dimensions.

The elements can be transformed (in a manner that will be described in detail below), while utilizing the transformation model 200, to a so-called latent space that represents a corresponding number of elements, each having M (M≤N) dimensions. In certain embodiments, M<N gives rise to a smaller volume of data in the latent space.

In addition to the specified elements, another input that is fed to the model 200 can be a desired probability function (designated p(z) 203) prescribing the desired allocation of the elements in the input space into one or more respective clusters of elements in the latent space, all as will be explained in greater detail below. The clusters may be characterized by a statistical distribution, all as will be described in greater detail below.

The inputs that are fed to the model may thus include the specified input elements, the pertinent N dimensions data, the desired probability function p (z) and the desired number M, informative of the number of dimensions in the latent space. Note that the N dimensions data includes specific designation of each dimension (e.g. the grey level value or, say, average brightness value etc.) whereas the M dimensions are not elaborated upon (apart from the number M being informative of the number of dimensions in the latent space) since their details are determined by the model, all as known per se.

The specified inputs to the model may be extracted for instance from the storage module 122. The data indicative of the elements and their related N dimensions associated with the image of the semiconductor specimen may be received for instance from the examination tool 120 and fed to the storage module through I/O module.

Intuitively, the goal of the transformation is to transform the elements from the input space (in N dimensions) into the latent space in M dimensions, to comply with the specified desired probability function 203 and some other conditions, as will be explained in greater detail below.

The transformation model that may be used is e.g. a known pe se neural network module (using, say, an autoencoder). The training of the model may be performed in an iterative manner, using the desired probability function to repeatedly transform, until a specified criterion is met e.g. a loss function meets a certain criterion, all as will be explained in greater detail below. During the training phase, elements in the input space will be transformed to an equal number of elements in the latent space in compliance with an actual probability function that is indicative of an actual allocation of the elements to the one or more respective clusters.

More specifically, and by way of example, in each iteration the elements in the input space are transformed (e.g. in transformation module 105) to the corresponding number of elements in compliance with the desired probability function. The transformed elements comply with an actual probability function q_{θ}(z) (see 204 in FIG. 2) which ideally should match the desired probability function p(z). Note that z represents the latent space and θ represents the parameters of the encoder 202. In a simple non-limiting case, all the elements in the latent space are allocated to a single cluster 3000, as will be illustrated with reference to FIG. 3A below. Naturally, in the first iteration, the “similarity” between the desired probability function and the actual probability function is not optimal, and thus additional iterations are required in order to improve the “similarity”. Note that the specified desired probability function and the actual probability function may be estimated by utilizing e.g. the known per se KDE algorithm.

The specified “similarity” may be determined e.g., by determining the statistical difference (see discussion with reference to L_{Prob} below) between the desired and actual probability functions. The latter is only one constituent which prescribes how many iterations will be performed until “success” is achieved, i.e., meeting a specified criterion.

Note that the model includes also: reconstructing 206 the M dimensional transformed elements (in the latent space) into reconstructed output elements x 207 utilizing reconstruction module (e.g. 107 in FIG. 1) which may be for example known per se decoder, all as will be explained in greater detail below.

In accordance with certain embodiments, in each iteration of training the transformation model 202, a training loss value L, associated with the elements in the latent space, is determined and tested (e.g. in criterion testing module 106—see FIG. 1 vis-a-vis a specified criterion, and, if the latter is met, the training completes. In accordance with certain embodiments, the training loss value L is determined based on at least:
a. a first term L_{Rec} indicative of a distance between the elements in the input space and elements in the output space re-constructible from the elements in the latent space; and
b. a second term, L_{Prob} indicative of statistical distance between the desired probability function 203 and the actual probability function 204.

In accordance with certain embodiments, calculating the specified statistical distance of the L_{Prob} constituent may utilize the known per se Jenson Shannon (JS) or Kullback-Leibler (KL) divergences.

In addition to the calculated L_{Prob} (being indicative of statistical distance between the probability functions), another constituent of the loss function L may be the L_{Rec} term. Intuitively, the latter indicates how “similar” the so-called output elements are (which are reconstructed from elements in the latent space) compared to the input elements in the input space. In this context, it should be noted that the elements in the latent space “adequately correspond” to the elements in the input space. This may be achieved by, e.g., reconstructing 206 output elements in an output space x (207) from the transformed elements in the latent space (208) utilizing, say, a decoder (206) that operates in an inverse fashion to the encoder 202 discussed above.

Once reconstructing the output elements, the “similarity” between the reconstructed output elements \hat{x} 207 and the input elements x is calculated (e.g. L_{Rec} being indicative of the distance between the input element and the reconstructed output elements). By way of example, L_{rec} complies with the following equation:

$${L}_{rec} = {‖ x - \hat{x} ‖}_{2}$$

Note that the specified equation corresponds to the distance between one input and one output element (or vice versa). In the case of calculating a distance between a plurality of elements (say in a batch mode-discussed below), the specified L_{rec} value between each two respective couple of input and output elements of the batch may be (for instance) averaged over all the couples of the batch, giving rise to a consolidated L_{rec} value being informative of the distance between a batch of input and output elements. The invention is not bound by the latter example.

Note also that that the decoding operation of the decoder 206 (being a constituent of the neural network model (200)) as discussed above, also undergoes training simultaneously to the encoder 202, all as will be explained in greater detail below.

Bearing this in mind, in accordance with certain embodiments the training loss value L is determined based on at least the specified L_{Prob} and L_{Rec} terms, (e.g. L=α*L_{Rec}+(1−α)*L_{Prob}) where 0<α<1 and is tested against a specified criterion, e.g., L should drop below a given threshold. Intuitively, the smaller the statistical difference L_{Prob} term, the more “similar” is the actual probability function to the desired probability function, and the smaller the L_{Rec} term, the more “similar” are the reconstructed output elements to the input elements. Note that the value of the coefficient α may be determined, depending upon the particular application.

It is thus noted that the reconstruction constituent of the model (e.g. decoder) is adequately trained until the N dimensional reconstructed elements x 207 are “sufficiency similar” to the input elements x. This may be achieved by determining the distance between x and x in a known per se manner. Note that the distance may be determined, e.g., on an element-by-element basis or batch of elements vs. batch of elements, etc. For instance, consider the non-limiting example that the model is fed serially (during training phase) with input elements, one after the other. Each of the input elements x is characterized by N dimensions (say N=n1*n1 pixel values associated with an input image). The reconstructed x may be a corresponding element having N dimensions (N=n1*n1 reconstructed pixel values). The distance may be calculated between the n1*n1 pixel values associated with the input image and the n1*n1 reconstructed pixel values. The procedure will be repeated with respect to the next input element (that is fed to the model) vs. its corresponding reconstructed element and so forth.

In accordance with another non-limiting example, the model is fed with a batch of B elements, one batch after the other. By this example, the distance is calculated between batches of elements. Thus, for example, consider a batch of B elements that is fed to the model, where each element in the batch is characterized by say N dimensions (all constituting x). The reconstructed batch of B elements is characterized by N dimensions (constituting x). The distance, by this example, may be calculated between the batch of input elements and the batch of reconstructed elements, all as discussed above. Note that the invention is not bound by these examples.

Once the specified criterion is met, the training can be terminated and the elements in the latent space may be processed and analyzed, all as will be exemplified in greater detail below.

Attention is drawn to FIG. 3A, illustrating, schematically, elements in the latent space that were transformed into a single cluster in compliance with a desired probability function, in accordance with certain embodiments of the presently disclosed subject matter. For simplicity, in the example of FIG. 3A, the input elements (not shown in FIG. 3A) are each characterized by N=2 dimensions, and the elements in the latent space 3000 are each characterized with two dimensions (M=2), such that each element may be represented as (z₁, z₂) value. The desired probability function is, say, Gaussian. The training of the model will undergo a few iterations until the transformation and reconstruction functions thereof will yield a loss function (e.g. the one described above) that meets a specified criterion, e.g. that L drops below a predefined threshold.

As mentioned above, the training of model (say neural network 200) involves the training of both the transformation and reconstruction functions (e.g. decoder 202 and decoder 206) simultaneously.

Note that the description of the system architecture with reference to FIG. 1 and the sequence of operations with reference to FIGS. 2 and 3 pertain to the system's training phase. In accordance with another aspect of the invention, there is provided a system configured to operate in inference phase. During the inference phase, a trained model (trained, for instance by following the sequence of operations described above with reference to FIGS. 2 and 3) may be utilized for analyzing elements in a latent space. As may be recalled, the latent space represents a plurality of elements, each having M dimensions that were transformed from elements in an input space having N (M≤N) dimensions and being associated with at least one image of a semiconductor specimen. The transformed elements comply with a given probability function. This aspect will now be described in greater detail.

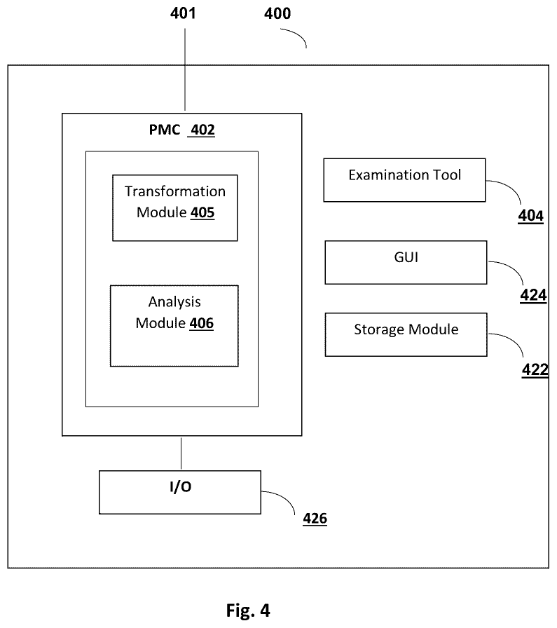

Thus, attention is drawn to FIG. 4 illustrating a generalized block diagram of an inference system in accordance with certain embodiments of the presently disclosed subject matter. System 401, PMC 402, and examination tool 420, storage module 422, GUI 424 and I/O 426 apply mutatis mutandis to the corresponding system 101, PMC 102 and examination tool 120, storage module 122, GUI 124 and I/O 416. Note that whereas the inference system will be described as a separate system with reference to FIG. 4, it may, in accordance with certain embodiments, be integrated partially or wholly with the training system as described with reference to FIG. 1. Thus, by way of example, in accordance with certain embodiments, any of the specified PMC, examination tool, storage module, GUI and I/O module, may be shared by the training system and inference system.

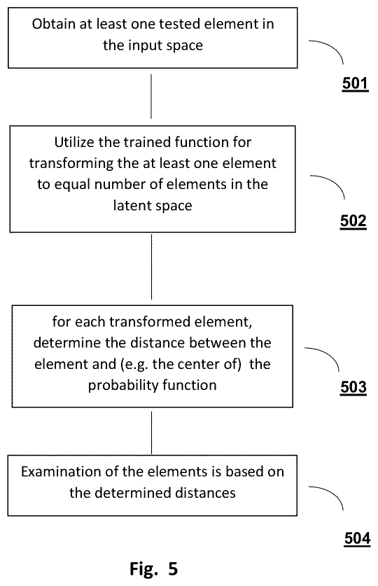

Specifically, system 401 may include a processor and memory circuitry (PMC) 402 operatively connected to a hardware-based I/O interface 426. The PMC 402 is configured to provide processing necessary for operating the system, as further detailed with reference to FIG. 5, and comprises one or more processors (not shown separately) operatively connected to a memory (not shown separately). The processor(s) of PMC 402 can be configured to execute several functional modules in accordance with computer-readable instructions implemented on a non-transitory computer-readable memory comprised in the PMC. Such functional modules are referred to hereinafter as comprised in the PMC.

Functional modules comprised in the PMC 402 of system 401 can include, e.g., a transformation module 405 and analysis module 406.

Operation of systems 100, 101, 102, and the PMC(s) thereof, as well as the functional modules therein, will be further detailed with reference to FIG. 5 for inference operation using a trained model in the latent space.

Thus, there follows a description of an inference sequence of operations in accordance with certain embodiments of invention with reference also to FIG. 5. For a better understanding, and for illustrative purposes only, the description will refer occasionally to the example of FIG. 3A illustrating, schematically, an outcome of a training phase, showing elements that fall into a single cluster, say, 3000 (characterized e.g. by Gaussian distribution), by this example in two dimensions in the latent space, where each element is represented in two dimensions (M=2), and which were transformed from elements in the input space (with N=2 dimensions) in compliance with a desired probability function, all in accordance with certain embodiments of the presently disclosed subject matter. The elements in the input space are associated with at least one image of a semiconductor specimen. For instance, during the training phase, elements in the input space that were transformed into elements that fall within the cluster 3000 were a priori selected to represent a nuisance specimen.

Intuitively, once the system is adequately trained and a newly fed input element is fed to the trained system (as acquired e.g., from a newly examined specimen), then, if this newly fed element is acquired from a nuisance specimen, it will be transformed and fall into the specified cluster (as elements in the latent space that correspond to a nuisance specimen (by this example) comply with the specified desired probability function, i.e. Gaussian distribution). Thus, in the latter example, all the elements in the latent space that originate from elements (in the input space) associated with the input image will comply with the Gaussian distribution and will fall inside cluster (e.g.) 3000. Thus, if in the following inference phase a newly fed input element represents, say, a defect, then most likely it will not be characterized by the specified desired probability function, and therefore it will be transformed into an element that does not fall inside the specified cluster 3000 but rather distanced from the center of the cluster (e.g. element 3001 drawn for clarity in enlarged shape). Note that throughout the description, the term center of (in the context of distance from a cluster/probability function) is an example of “distance with reference to the cluster”, meaning that the distance is not measured necessarily relative to the center, but possibly to other point or points of interest that are associated with the cluster (probability function).

Consider, by way of example, another embodiment where the model was trained with a blend of, say a majority of/nuisance and minority of j defect input elements (j<<i) but still with the constraint of, say, Gaussian distribution, as outlined in FIG. 3A. By this example there may be higher likelihood that elements in the input space that represent a nuisance specimen will be transformed to corresponding elements in the latent space that are more concentrated close to the center of cluster 3000 (say 3002), whereas elements in the input space that represent a defected specimen will be transformed to corresponding elements in the latent space that are more distanced from the center of cluster 3000 (say 3003). While not necessarily so, the process of operation of systems 401 and 400 can correspond to some or all of the stages of the methods described with respect to FIG. 5. Likewise, the method described with respect to FIG. 5 and its possible implementations, can be implemented by systems 401 and 400, possibly utilizing modules 405 and 406. It is therefore noted that embodiments discussed with respect to FIG. 5 can also be implemented, mutatis mutandis, as various embodiments of systems 401 and 400, and vice versa.

Bearing this in mind, attention is drawn to FIG. 5. Thus, at the onset 501, at least one element in the input space is obtained that is associated with an image of a semiconductor specimen. Then, at 502 the trained model is utilized for transforming the at least one element to equal the number of elements in the latent space (performed e.g., in transformation module 405—see FIG. 4. Then, for each transformed element, the distance between the element and the (e.g. center of) probability function is determined 503. And, lastly, at 504 examination of the element may be carried out, the element being based on the determined distance (e.g. in analysis module 406).

Consider the example of training the model with only elements that represent a nuisance specimen. For instance, if the distance of the transformed element from the center of the cluster falls below a given threshold, then examination of the element will yield a nuisance specimen. If, on the other hand, it exceeds the specified threshold (i.e., deviating from the cluster) this may indicate an anomaly, possibly a defect, and may be further processed in a known per se manner.

There may be other implementations of the inference phase, all as will be described in greater detail below.

Having described an exemplary inference sequence of operations in accordance with certain embodiments of the invention, attention is reverted to the training phase (with reference to FIGS. 2 and 3) for illustrating additional non-limiting examples. As may be recalled, transformation to the latent space is not confined to only one cluster, but in accordance with certain embodiment to two or more (I≥2) mutually discernible clusters. By this embodiment, the input fed to the system further includes data indicative of a number (K≥I) of classes, each associated with a respective group of classes for each cluster, giving rise to/groups of classes, and further, that each element of at least a subset of the input space is labeled with a selected class of said K classes.

For simplicity of explanation, consider the non-limiting example of two clusters and two classes, and that the input elements are labeled with either one of said classes. By way of non-limiting example, the first class is indicative of nuisance portions of wafer(s) or die(s) that are derived from, say, a first process variation, and the other class is indicative of nuisance portions of wafer(s) or (die) that are derived from, say, a second process variation. The desired probability function that includes, by this example, two distinct clusters, aims at transforming the elements that are derived from the first process variation (labeled class A) to elements that will fall into the first cluster, and the elements that are derived from the second process variation (labeled Class B) to elements that will fall into the second cluster. Assume further for simplicity that each of the clusters is characterized by a distinct Gaussian distribution.

The underlying assumption in the latter simplified example is that the images of nuisances that that are derived from the class A should comply (after adequately training the transformation function) with a common distribution (say the Gaussian centered at the first cluster (say, c₁ in FIG. 3B), and that images of the nuisance wafers that originate from the class B of nuisances should comply (after adequately training the transformation function) with a common but yet different distribution (say the Gaussian centered at the second cluster (say, c₂ in FIG. 3B)). Note that the training of the model by this example is a supervised learning.

For a better understanding of the latter example, attention is drawn to FIG. 3B illustrating, schematically, elements in the latent space that were transformed into two clusters in compliance with a desired probability function, in accordance with certain embodiments of the presently disclosed subject matter. The example in FIG. 3B assumes, for simplicity, M=2 dimensions of the transformed elements in the latent space, illustrated as two-dimensional representation, where any transformed element may be represented as an (z₁, z₂) value.

FIG. 3B illustrates the result that is achieved after repeatedly training the transformation model utilizing for e.g., neural network 200 of FIG. 2, where e.g., each of the input elements is labeled with either the first class or the second class discussed above. Thus, after adequate repeated training of the model, the input elements labeled with the first class should preferably be transformed into elements in the latent space that fall within the first cluster 311 (marked in hashed circumference and representing say a first Gaussian distribution), and the input elements labeled with the second class should preferably be transformed into elements in the latent space that fall into the second cluster 312 (marked in hashed circumference, and representing, say, a second Gaussian distribution). By this example, clusters 311 and 312 are included in probability function 300 and may be characterized by Gaussian Mixture Modeling (GMM).

Moving on with FIG. 3B, The dark grey area 313 shows a plurality of “dots” each representing an element in the latent space that falls in the first cluster 311, and the bright grey area 314 shows a plurality of “dots” each representing an element in the latent space that falls in the second cluster 312.

Note, incidentally, that, for simplicity, each cluster is indicative of a known statistical distribution.

Reverting now to FIG. 3B, which, as indicated above, represents the endgame after repeatedly training the transformation function.

In order to achieve the designated result that the elements will fall into the designated cluster, the loss function L may be modified. As may be recalled, in accordance with certain embodiments (discussed above,) the loss function L complies with the following equation L=σ*L_{Rec}+(1−α)*L_{prob} and if L is tested and meets a specified criterion, the training is successful, meaning, intuitively, that the transformed elements in the latent space when reconstructed (e.g. decoded into the output space) will be “sufficiently similar” to the input element, and, in addition, the actual probability function (204) will be “sufficiently similar” to the desired probability function (203). By way of example, consider the example of FIG. 3B, and assume that the clusters associated with the desired probability function both characterize Gaussian distribution, then the actual clusters 311 and 312 of the actual probability function 300 characterize the desired respective distributions.

Hence, in accordance with certain embodiments, the loss function L is modified to determine the training loss L value based also on:
a third term, L_{Sup} indicative of a degree of allocation of the transformed elements, labeled with classes to a corresponding cluster of said I clusters, such that the fewer the transformed elements that are allocated to other than said corresponding cluster of said/clusters, the lower said L_{Sup} value.

Thus, in the example of FIG. 3B, L_{Sup} gets lower if fewer elements are allocated to “the wrong cluster”. Thus, by this example, the fewer the “bright” elements 314 that are allocated to cluster 311 and/or the fewer “dark” elements 313 that are allocated to cluster 312, the lower the L_{Sup} value will be.

Note that the specified L_{Sup} equation is only a non-limiting example. By way of example, in case the clusters do not constitute a circle, obviously, the r value is not relevant.

Thus, in accordance with a certain embodiment, the training loss value L complies with the following equation:
α*L_{Rec}+β*L_{Prob}+(1−α−β)*L_{Sup} where 0<α+β<1 and L_{Sup} complies with the specified equation. Note that the values of the coefficients α and/or β may be determined, depending upon the particular application.

The description above referred, for simplicity, to the case of M=2 (two dimensions in the latent space) and two classes. The invention is, of course, not bound by this example.

Note that the supervised learning described above was exemplified with respect to two classes, one that refers to elements that originate from a first type of nuisance (say informative of a first process variation), and the other that refers to elements that originate from a second type of nuisance (say informative of a second process variation). The invention is, of course, not bound by this example of elements and classes that may be fed to the model for training. Thus, by way of another example, two classes that represent corresponding different types of nuisance elements may be used, or by a still further non-limiting example, two different classes that represent corresponding different types of defects of interests (DOI) may be used, say a first type of DOI that originates from a bridge, and a second type of DOI that originates form a particle.

By yet another example, the two classes may be assigned to elements informative of a nuisance (labeled as class A) and another to elements informative of a DOI (labeled as class B). Note that the invention is not bound by these examples. Obviously only two classes were discussed for illustrative purposes and by other embodiments elements that are labeled with more than two classes may be fed to the model.

In accordance with certain other embodiments, the input data 201 includes data indicative of a number (K≥I) of classes, each associated with a respective group of classes for each cluster, giving rise to I groups of classes. Each group of classes corresponds to a cluster. For a better understanding of the foregoing, consider, for example, FIG. 3C, showing input data 330 that is associated with two groups (by this example I=2 groups) marked as 331 and 332, respectively. Group 331 is associated with two classes A and B, and group 332, in turn, is associated with classes C and D. In other words, by this example, during the training phase, and as described in detail with reference to FIGS. 2 and 3B above, each (or subset) of the input elements is labeled with any of classes A to D.

Moving on with the example of FIG. 3C, the distribution function is associated with two clusters, by this example 333 and 334, that correspond to the number of groups (by this example, two). As readily shown in the example of FIG. 3C, it is desired that the elements tagged with classes A or B (and which belong to group 331) will be transformed into cluster 333 in the latent space, and that the elements tagged with classes C or D (and which belong to group 332) will be transferred to cluster 334 in the latent space. Thus, by this specific example, there are K=4 classes, I=2 groups and corresponding I=2 clusters.

In accordance with the description above, if the loss function L (e.g. α*L_{Rec}+B*L_{Prob}+(1−α−β)*L_{Sup}) meets the specified criterion, then the input elements will be transformed and assigned to the desired two clusters (as tested by the L_{Prob} term), will adequately fall into the corresponding cluster (333 or 334) as per their labeled class (as tested by the L_{Sup} term) and will be reconstructed in the output space 335 (from the elements in the latent space) in “sufficient similarity” to the elements in the input space (as tested by the L_{Rec} term). Note that by the specific example of FIG. 3C, the clusters in the latent space 333 and 334 comply with the actual probability function q which in its turn is sufficiently similar to the desired probability function p (as depicted schematically by the two clusters in 336).

FIG. 3D illustrates a similar transformation training as in FIG. 3C, except for the fact that the tested loss function L does not consider the allocation of the elements to the clusters according to the class of the element. Thus, by this example, the loss function/may be based on α*L_{Rec}+(1−α)*L_{Prob} and requiring that L meets the specified criterion. Note that L_{Sup} is obviated in the calculation and therefore the specified loss function L may meet the specified criterion, even if the elements are assigned to clusters other than their designated class. Thus, by way of example, whereas and as shown in FIG. 3C, elements labeled with class A or B are ideally assigned to cluster 333, and elements labeled with class C or D are ideally assigned to cluster 334 in FIG. 3D. Because of the fact that the L_{Sup} is not considered, cluster 333 may include also elements that are labeled C, although the latter should preferably fall into cluster 334 (see FIG. 3C).

Note that by way of non-limiting example, each of the clusters of the probability function illustrated in FIGS. 3C and 3D may be characterized by a known distribution, say Gaussian.

FIG. 3E, illustrates, in turn, a similar scenario as the one described with reference to FIG. 3C. However, in FIG. 3E, the statistical function 350 may be characterized by a Gaussian distribution and is composed of two clusters 351 and 352 respectively divided by border line 353, such that elements tagged A or B are transformed into elements that fall into cluster 351 (i.e. they are “above” the border line 353) and elements tagged C or D are transformed into elements that fall into cluster 352 (i.e. they are “below” the border line 353). Note also that the L sup constituent of the loss function L which aims at splitting the transformed elements “above” and “below” border line 353 is different than the L sup discussed with reference to FIG. 3B (aimed at discerning between preferably (although not necessarily) non-overlapping clusters).

The invention is of course not bound by the specified L_{SUP} examples.

The specified examples with reference to FIGS. 3C-E were provided for illustrative purposes only, and are by no means binding. For instance (and in order to be presented graphically) assume only M=2 dimensions in the latent space and N=2 dimensions in the input space.

Note that whereas the discussion above exemplified supervised learning and non-supervised learning (the latter does not utilize class labels), in accordance with certain embodiments, the invention embraces also semi-supervised learning where part of the elements that are fed to the model are labeled with appropriate classes and others are not, mutatis mutandis.

Note also that whereas the description with reference to FIGS. 3C-E concerned more classes than clusters, in accordance with other embodiments, elements with I classes may be transformed J clusters (I<J) in the latent space, for example elements that are tagged with one of I possible classes may be fed to a model with the constraint that the latent space should comply with J>I.

Having described various embodiments of the training aspect of the invention, attention is drawn again to the interference aspect that was described, e.g., with reference to FIG. 5 above. There may be applications other than the anomaly detection described above. For instance, in accordance with certain embodiments of the invention, the interference phase may be directed to determine whether a tested element falls into any of the given clusters. Thus, for example, consider the example of FIG. 3B. After adequately training the encoder to transform input elements to fall into the latent space to either cluster 311 or 312, depending on the class label that is assigned to the training set of elements, in the following inference phase a tested element may be fed to the system and is transformed (using trained encoder 202—see FIG. 2) to location 315 in the latent space. Now the transformed elements may be tested to determine to which cluster they belong. Considering that it is closer (e.g., a shorter distance to the center) to cluster 311 than 313, it is determined that it belongs to the former, and not the latter. This may be representative of the following real-life scenario.

In accordance with yet another non-limiting example of inference application, the system may be utilized for generating synthetic examples. Consider, for example, the following scenario with reference to, say, FIG. 3C. The system has been adequately trained to transform elements that are labeled as class A to fall into the A area of cluster 333. As explained above, all the transformed elements in the latent space originate from corresponding elements in the input space (class A elements of input space 331). Assume, for sake of discussion, that there is a need to obtain further input elements (of class A). It is, thus, desired to generate qualitative “synthetic examples” i.e., generate high quality synthetic input elements that will resemble true input elements. Considering that the model is adequately trained, it is guaranteed that the actual probability function q is sufficiently similar to the desired probability function p and that the reconstructed output elements are sufficiently similar to the input element. Thus, in accordance with certain embodiments, a sample point is generated from the desired probability function p (z) and then processed through the decoder of the model to get a new reconstructed output element sample. Considering that the reconstructed output elements can be used as input elements, the latter (output element) can serve as a synthetic input element for, say, training other models. In case that the newly trained model requires a lot of data in the training stage, the latter procedure may be utilized to generate as many as required new qualitative (synthetic) input elements for training the new model.

In accordance with certain embodiments, the at least one of the following advantages are obtained:
(i) a more efficient analysis of elements associated with the actual probability function that is sufficiently similar to the desired probability function in the latent space, rather than hypothetical analysis of the elements in the input space which inherently do not comply with the specified desired probability function.
(ii) In the case of M<N dimensions, a more efficient analysis of the elements (characterized by M<N dimensions) in the latent space, rather than hypothetical analysis of the elements (characterized by N>M dimensions) in the input space. The term “more efficient” is referred to herein as more efficient in terms of computational complexity and/or smaller required computer storage space.

Note that the invention is not bound by the specified examples of utilizing the trained system in the inference phase, which are provided for illustrative purposes only.

It is to be noted that examples and numeral values illustrated in the present disclosure, such as, e.g., specified N and M dimensions, the statistical distance and/or or distance criterion, and others, are illustrated for exemplary purposes and should not be regarded as limiting the present disclosure in any way. Other appropriate examples/implementations can be used in addition to, or in lieu of the above.

Note also that any mathematical term that is used herein should be construed to include also equivalents thereof.

In the detailed description, numerous specific details are set forth in order to provide a thorough understanding of the disclosure. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the discussions, it is appreciated that, throughout the specification, discussions, utilizing terms such as monitoring, embodying, determining, representing, analyzing, and comprising, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities as described, e.g., with reference to FIG. 1 or 4.

The processor referred to in the current disclosure can represent one or more general-purpose processing devices, such as a microprocessor, a central processing unit, or the like. More particularly, the processor may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processor may also be one or more special-purpose processing devices, such as an application specific integrated circuit (ASIC), a field programmable gate array (FPGA), a digital signal processor (DSP), a network processor, or the like. The processor is configured to execute instructions for performing the operations and steps discussed herein.

The memory referred to herein can comprise a main memory (e.g., read-only memory (ROM), flash memory, dynamic random-access memory (DRAM) such as synchronous DRAM (SDRAM) or Rambus DRAM (RDRAM), etc.), and a static memory (e.g., flash memory, static random-access memory (SRAM), etc.).

The terms “non-transitory memory” and “non-transitory storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

The term “specimen” used in this specification should be expansively construed to cover any kind semiconductor specimens such as wafers, masks, reticles, and other structures, combinations and/or parts thereof which may be used, for example, for manufacturing semiconductor integrated circuits, magnetic heads, flat panel displays, and other semiconductor-fabricated articles. A specimen is also exemplified herein as a semiconductor specimen and can be produced by manufacturing equipment executing corresponding manufacturing processes.

The term “examination” used in this specification should be expansively construed to cover any kind of operations related to defect detection, defect review and/or defect classification of various types, segmentation, and/or other operations during and/or after the specimen fabrication process. Examination is provided by using non-destructive examination tools during or after manufacture of the specimen to be examined. By way of non-limiting example, the examination process can include runtime scanning (in a single or in multiple scans), imaging, sampling, detecting, reviewing, measuring (including, e.g., measurements of characteristics of specimen holes and hole's bottom), classifying and/or other operations provided with regard to the specimen or parts thereof, using the same or different inspection tools. Likewise, examination can be provided prior to manufacture of the specimen to be examined, and can include, for example, generating an examination recipe(s) and/or other setup operations. It is noted that, unless specifically stated otherwise, the term “examination”, or its derivatives used in this specification, are not limited with respect to resolution or size of an inspection area. A variety of non-destructive examination tools includes, by way of non-limiting example, scanning electron microscopes (SEM), atomic force microscopes (AFM), optical inspection tools, etc.

The term “examination tool(s)” used herein should be expansively construed to cover any tools that can be used in examination-related processes, including, by way of non-limiting example, scanning (in a single or in multiple scans), imaging, sampling, reviewing, measuring, classifying, and/or other processes provided with regard to the specimen or parts thereof.

It is to be noted that, the term “image(s)” used herein can refer to original images of the specimen captured by the examination tool during the manufacturing process, derivatives of the captured images obtained by various pre-processing stages, and/or computer-generated design data-based images. It is to be noted that in some cases the images referred to herein can include image data (e.g., captured images, processed images, etc.) and associated numeric data (e.g., metadata, hand-crafted attributes, etc.). It is further noted that image data can include data related to one or more layers of interest of the specimen.

The terms “similar” or “sufficiently similar”, “distance”, and “statistical distance” used in this specification should be expansively construed to cover, in accordance with certain embodiments, any kind of well-known techniques such as measuring distances (e.g. L1 Norm, L2 Norm), and measuring statistical distances (e.g. KL divergence, JS divergence).

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the following detailed description, numerous specific details are set forth in order to provide a thorough understanding of the methods and apparatus.

Note that in accordance with certain embodiments, the order of computational stages described herein with reference to the drawings is not necessarily binding. For instance, the order of steps may be changed, steps may be modified or deleted, and/or other steps may be added instead of or in addition to those disclosed herein.

It is to be understood that the present disclosure is not limited in its application to the details set forth in the description contained herein or illustrated in the drawings.

It will also be understood that the system, according to the present disclosure, may be, at least partly, implemented on a suitably programmed computer. Likewise, the present disclosure contemplates a computer program being readable by a computer for executing the method of the present disclosure. The present disclosure further contemplates a non-transitory computer-readable memory tangibly embodying a program of instructions executable by the computer for executing the method of the present disclosure.

The present disclosure is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the present disclosure as hereinbefore described without departing from its scope, defined in and by the appended claims.

1. A system for training a model representing a plurality of elements in the input space, each having N dimensions and being associated with at least one image of a semiconductor specimen, to a latent space representing an equal plurality of elements, each having M (M≤N) dimensions, the system comprising a processing and memory circuitry (PMC) configured to:
a) obtain a desired probability function for transformation of the elements in the input space into one or more respective clusters of elements in the latent space;
b) using the desired probability function to repeatedly transform, until a specified criterion is met, elements in the input space to equal the plurality of elements in the latent space in compliance with an actual probability function that is indicative of an actual allocation of the elements to the one or more respective clusters;
c) determining a training loss value L associated with the elements in the latent space and testing if said training loss value L meets the specified criterion; said training loss value L being determined based on at least:
a. a first term L_{Rec} indicative of a distance between the elements in the input space and elements in an output space reconstructed from the elements in the latent space; and
b. a second term, L_{Prob} indicative of statistical distance between the desired probability function and the actual probability function.

2. The system according to claim 1, wherein said training loss value L complies with the following equation:
$$α * {L}_{Rec} + ( 1 - α ) * {L}_{Prob}$$

3. A system according to claim 1, for facilitating more efficient analysis of elements associated with the actual probability function that is sufficiently similar to the desired probability function in the latent space, rather than hypothetical analysis of the elements in the input space which inherently do not comply with the specified desired probability function.

4. The system according to claim 1, wherein said training is a semi or fully supervised learning such that at least some of said plurality of elements in the input space are labeled with respective class of at least two classes for transformation of the elements in the input space into elements in one or more respective clusters of elements in the latent space.

5. The system according to claim 4, wherein:
elements in the input space are allocated to a number (I≥2) of mutually discernible clusters in the latent space and the (PMC) is further configured to:
a) obtain data indicative of a number (K≥I) of classes each associated with a respective group of classes for each cluster, giving rise to/groups of classes;
b) label each element of at least a subset of the input space with a selected class of said K classes;
c) determine the training loss L value based also on:
a third term, L_{Sup} indicative of a degree of allocation of the transformed elements, labeled with classes each associated with a respective group of said/group of classes, to a corresponding cluster of said I clusters, such that the fewer the transformed elements that are allocated to other than said corresponding cluster of said/clusters, the lower said L_{Sup} value.

6. The system according to claim 4, wherein said training loss value L complies with the following equation:
$$α * {L}_{Rec} + β * {L}_{Prob} + ( 1 - α - β ) * {L}_{Sup}$$

7. The system according to claim 3, wherein:
elements in the input space are allocated to a number (I≥2) of mutually discernible clusters in the latent space and the (PMC) is further configured to:
a) obtain data indicative of a number (k<I) of classes;
b) label each element of at least a subset of the input space with a selected class of said K classes;
c) determine the training loss L value based also on:
a third term, L_{Sup} indicative of a degree of allocation of the transformed elements, labeled with k classes to a corresponding cluster of said I clusters, such that the fewer the transformed elements that are allocated to other than said corresponding cluster of said/clusters, the lower said L_{Sup} value.

8. The system according to claim 1, wherein said model being a neural network that includes an encoder and decoder.

9. The system according to claim 1, wherein the statistical distance between the desired probability function and the actual probability function is calculated utilizing Jenson Shannon or Kullback-Leibler divergences.

10. The system according to claim 1, wherein at least one of said clusters is characterized by a known statistical distribution.

11. The system according to claim 4, wherein at least two of said clusters are characterized by Gaussian Mixture Modeling (GMM) or Gaussian.

12. The system according to claim 1, wherein the N dimensions input space associated with at least one image are informative of pixel values and/or at least two of the following: average intensity level, deviation from average pixel value, defect size, SNR (signal to noise ratio), correlation with predefined template, image moments.

13. A system for utilizing a trained model for analyzing elements in a latent space; the latent space representing a plurality of elements each having M dimensions that were transformed from elements in an input space having N (M≤N) dimensions and being associated with at least one image of a semiconductor specimen; the transformed elements comply with a probability function; the system comprising a processing and memory circuitry (PMC) configured to:
a) obtain at least one element in the input space that is associated with an image of a semiconductor specimen;
b) utilizing the trained model for transforming the at least one element to an equal number of elements in the latent space;
c) for each transformed element, determine the distance between the element and reference to the probability function, wherein examination of the element is based on the determined distance.

14. The system according to claim 13, wherein said reference to the probability function being the center of said probability function.

15. The system according to claim 13, wherein said model was trained by a PMC, including:
a) obtaining a desired probability function for transformation of the elements in the input space into one or more respective clusters of elements in the latent space;
b) using the desired probability function to repeatedly transform, until a specified criterion is met, elements in the input space to equal the plurality of elements in the latent space in compliance with an actual probability function that is indicative of an actual allocation of the elements to the one or more respective clusters;
c) determining a training loss value L associated with the elements in the latent space and testing if said training loss value L meets the specified criterion; said training loss value L being determined based on at least:
a. a first term L_{Rec} indicative of a distance between the elements in the input space and elements in an output space reconstructed from the elements in the latent space; and
b. a second term, L_{Prob} indicative of statistical distance between the desired probability function and the actual probability function.

16. The system according to claim 13, wherein said analysis includes determining anomality of the transformed elements.

17. The system according to claim 13, wherein said analysis includes determining association of each transformed element to a cluster of said clusters.

18. The system according to claim 13, wherein said analysis includes generating at least one new element in the latent space being re-constructible to a corresponding at least one output element in the output space wherein
each of the at least one output element constitutes a new synthetic input element for training a model.

19. A method for training a model representing a plurality of elements in the input space each having N dimensions and being associated with at least one image of a semiconductor specimen, to a latent space representing an equal plurality of elements each having M (M≤N) dimensions, the method comprising, by a processing and memory circuitry (PMC):
a) obtaining a desired probability function for transformation of the elements in the input space into one or more respective clusters of elements in the latent space;
b) using the desired probability function to repeatedly transform, until a specified criterion is met, elements in the input space to equal the plurality of elements in the latent space in compliance with an actual probability function that is indicative of an actual allocation of the elements to the one or more respective clusters;
c) determining a training loss value L associated with the elements in the latent space and testing if said training loss value Z meets the specified criterion; said training loss value L being determined based on at least:
a. a first term L_{Rec} indicative of a distance between the elements in the input space and elements in an output space reconstructed from the elements in the latent space; and
b. a second term, L_{Prob} indicative of statistical distance between the desired probability function and the actual probability function.

20. A method for utilizing a trained model for analyzing elements in a latent space; the latent space representing a plurality of elements each having M dimensions that were transformed from elements in an input space having N (M≤N) dimensions and being associated with at least one image of a semiconductor specimen; the transformed elements comply with a probability function; the method comprising, by a processing and memory circuitry (PMC):
a) obtaining at least one element in the input space that is associated with an image of a semiconductor specimen;
b) utilizing the trained model for transforming the at least one element to an equal number of elements in the latent space;
c) for each transformed element, determining the distance between the element and reference to the probability function, wherein examination of the element is based on the determined distance.

21. A non-transitory computer readable storage medium tangibly embodying a program of instructions that, when executed by a computer, cause the computer to perform a method for training a model representing a plurality of elements in the input space, each having N dimensions and being associated with at least one image of a semiconductor specimen, to a latent space representing an equal plurality of elements each having M (M≤N) dimensions, the method comprising, by a processing and memory circuitry (PMC):
a) obtaining a desired probability function for transformation of the elements in the input space into one or more respective clusters of elements in the latent space;
b) using the desired probability function to repeatedly transform, until a specified criterion is met, elements in the input space to equal the plurality of elements in the latent space in compliance with an actual probability function that is indicative of an actual allocation of the elements to the one or more respective clusters;
c) determining a training loss value L associated with the elements in the latent space and testing if said training loss value L meets the specified criterion; said training loss value L being determined based on at least:
a. a first term L_{Rec} indicative of a distance between the elements in the input space and elements in an output space reconstructed from the elements in the latent space; and
b. a second term, L_{Prob} indicative of statistical distance between the desired probability function and the actual probability function.

22. A non-transitory computer readable storage medium tangibly embodying a program of instructions that, when executed by a computer, cause the computer to perform a method for utilizing a trained model for analyzing elements in a latent space; the latent space representing a plurality of elements each having M dimensions that were transformed from elements in an input space having N (M≤N) dimensions and being associated with at least one image of a semiconductor specimen; the transformed elements comply with a probability function; the method comprising, by a processing and memory circuitry (PMC):
a) obtaining at least one element in the input space that is associated with an image of a semiconductor specimen;
b) utilizing the trained model for transforming the at least one element to an equal number of elements in the latent space;
c) for each transformed element, determine the distance between the element and reference to the probability function, wherein examination of the element is based on the determined distance.
